(19) United States
(12) Patent Application Publication
(10) Pub. No.: US 2005/0074319 A1
(43) Pub. Date: Apr. 7, 2005

(54) Machine operator protective guard

(76) Inventors: Joseph M. Patsco, Little Silver, NJ (US); Edwardo Santiago, Levittown, PA (US); Gerald Robert Tacinelli, Stanhope, NJ (US); Jose Aracena, Robbinsville, NJ (US); William J. Carothers, Melville, NY (US)

Correspondence Address: FURGANG & ADWAR, 2 CROSFIELD AVENUE, WEST NYACK, NY, 10994, US

(21) Appl. No.: 10/680,333

(22) Filed: Oct. 7, 2003

(51) Int. Cl. B65G 1/00

(52) U.S. Cl. 414/661

(57) ABSTRACT

A machine operator protective guard extends upwardly from the rear edge of the operator platform. The top of the protective guard is attached to the operator cage to increase the stability and sturdiness of the protective guard. The protective guard includes a bowed out section increasing room in which the operator can maneuver. This bowed out portion extends horizontally outwardly an additional three to five inches from the top and bottom attachment points of the protective guard. In addition, extensions extend inwardly from the side edges of the protective guard to increase the protection afforded to the operator from falling or shifting merchandise. A flat has a bed and a fence extends upwardly from the bed. The fence is positionable at a plurality of locations along the bed. The distance between the fence and the protective guard can be adjusted to suit the merchandise being transported.

### BACKGROUND OF THE INVENTION

Warehouses store inventory on large shelves, often extending the full height of the warehouse. This height can easily reach 20 feet or greater. When inventory needs to be retrieved, especially from higher shelves, workers will use an order picker having forks supporting a pallet or flat. The inventory is loaded onto the pallet or flat and transported.

Order pickers resemble fork lifts and have an operator's cab formed by an operator's platform on which the operator stands, and an operator's cage, usually incorporating a horizontally extending portion above the operator. A common type of order picker has a forwardly located motor for providing power to move the order picker and to raise and lower the operator's cab along vertical towers to reach highly placed inventory. Forks for transporting the inventory extend rearwardly from the operator's platform. Since the operator faces forward to operate controls to move the order picker, the operator's back is to the inventory.

The movement of inventory from higher shelves and from one location in a warehouse to another, as needed, presents the possibility that inventory will shift on the platform or flat supported by the fork. Such inventory shifts may lead to injury of the operator if the inventory falls on to the operator. There is a need in the art for protective guards to prevent injury from shifting and falling inventory placed on the order picker.

### SUMMARY OF THE INVENTION

A machine operator protective guard extends upwardly from the rear edge of the operator platform. The top of the protective guard is attached to the operator cage to increase the stability and sturdiness of the protective guard. The protective guard includes a bowed out section increasing room in which the operator can maneuver. This bowed out portion extends horizontally outwardly an additional three to five inches from the top and bottom attachment points of the protective guard. In addition, extensions extend inwardly from the side edges of the protective guard to increase the protection afforded to the operator from falling or shifting merchandise.

An order picker has a frame having a front and a rear. A motor for providing power is at the front of the frame with an operator's platform for supporting an operator located rearwardly of the motor. The platform has a front edge, a rear edge and a pair of side edges. A protective guard extends upwardly from the platform rear edge.

A protective guard has a pair of vertical posts, each vertical post has a first section and a second section. The second section extends rearwardly of the first section and a top rail extending between the pair of vertical posts.

A method of protecting an operator of an order picker includes providing an order picker having a frame having a front and a rear. A motor provides power at the front of said frame. An operator's platform for supporting an operator is located rearwardly of the motor, the platform has a front edge, a rear edge, and a pair of side edges, and attaching a protective guard extending upwardly from said platform rear edge.

It is an advantage of the invention to provide a protective railing extending vertically from the rear edge of the operator's platform.

It is another advantage of the invention to provide a protective guard for an operator to prevent injury from falling and shifting merchandise.

It is another advantage of the invention to provide a protective guard for an order picker that may be added to existing order pickers.

It is yet another advantage of the invention to provide a protective guard for an operator having increased room for the operator. These and other advantages of the invention will become apparent to one of ordinary skill in the art after reviewing the disclosure of the invention.

In accordance with this invention there is provided an order picker which comprises a frame having a front and a rear. There is also provided a motor for providing power at the front of the frame. An operator's platform is provided for supporting an operator located rearwardly of said motor, said platform having a front edge, a rear edge and a pair of side edges. There is further provided a protective guard extending upwardly from said platform rear edge.

Also in accordance with this invention there is provide a protective guard which comprises a pair of vertical posts. Each vertical post has a first section and a second section, the second section extends rearwardly of the first section, and a top rail which extends between the pair of vertical posts.

### BRIEF DESCRIPTION OF THE DRAWINGS

FIG. 1 is a side view of an order picker incorporated a protective guard of the invention;

FIG. 2 is a rear view of an order picker having the protective guard of the invention;

FIG. 3 is a top view of the protective guard attached to the order picker;

FIG. 4 is an alternative embodiment of the protective guard;

FIG. 5 is a top view of a flat used with the invention;

FIG. 6 is a side view of the flat with the fence in the rearward position;

FIG. 7 is a side view of the flat in a middle position; and

FIG. 8 is a view of the order picker having a protective guard and flat with the fence.

### DETAILED DESCRIPTION OF THE INVENTION

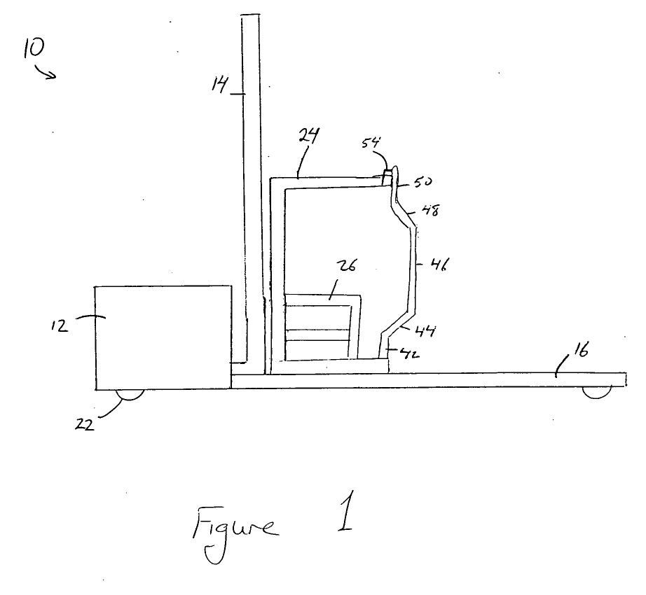

An order picker can be seen in FIG. 1. The order picker has a forwardly located motor 12 and a rearwardly extending frame 16. An operator's cab is formed by an operator's platform 20 and cage 24 having a first portion extending upwardly from the forward edge of the platform and a horizontally extending second portion located above the operator. A railing 26 is provided along the side edges of the operator's platform. Between the motor 12 and cage is a vertically extending tower 14. The motor 12, in addition to providing power to move the order picker also provides power to raise and lower the cab along the tower 14.

Protective guard 40 is seen attached to the rearward edge of the operator's platform 20. The guard has a first section 42 extending vertically upwardly from the platform. The bottom of the first section is attached to the operating platform to provide stability. A second outwardly extending section 44 extends from the top of the first section 42. A third vertically extending section 46 extends upwardly from the second section and joins a fourth inwardly extending section 48. The fourth section attaches to the fifth section 50 which lies against the rear edge of the operator's cage. A pair of L-shaped hooks 54 extend forwardly from the protective guard and hook into the horizontal portion of the operator's cage to further provide stability. The outward bend created by the inwardly and outwardly extending sections 42,48 and vertically extending sections provide additional room in which the driver can operate. This is particularly advantageous when the operator is a large person.

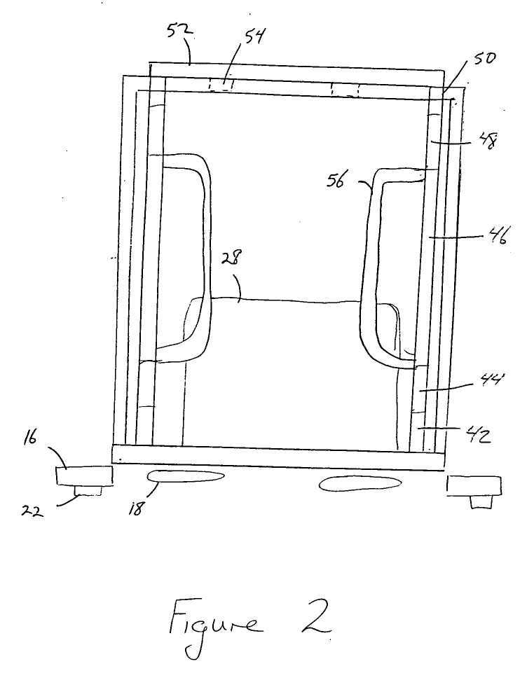

The rear view of the order picker having a protective guard is seen with reference to FIG. 2. Seen in this Figure are the frame 16 supported by wheels 22 with forks 18 positioned between the frame for engaging a flat or pallet. The cage 24 can be seen, along with the protective guard 40. As labeled in the figure, the vertically extending sections of the guard include the first section 42, second section 44, third section 46, fourth section 48 and fifth section 50 as described earlier. The two vertically extending sections of the protective guard 40 are connected by a top rail 52. The top rail 52 is positioned immediately above the top of the operator's cage 24 allowing L-shaped hooks 52 extending from the top rail 52 to extend over and down into the top of the cage 24.

Also clearly seen in this view are the inwardly extending extensions 56. The generally U-shaped extensions have a top and bottom portion extending from the third section 46 of the protective guard. Their connection is preferably at the top and bottom of the third section 46 to give them the greatest vertical extent. The extensions extend inwardly to prevent any shifting or falling merchandise from fitting between the vertical extending posts of the guard 40 and possibly striking the operator causing injury. The extensions also allow the driver to pass through the guard from a flat to enter the cab. Also seen in this view are the controls 28 used by the operator. It is during the use of the controls 28 that the operator's back faces the merchandise, leaving the operator unaware of any potential injury from falling or shifting merchandise.

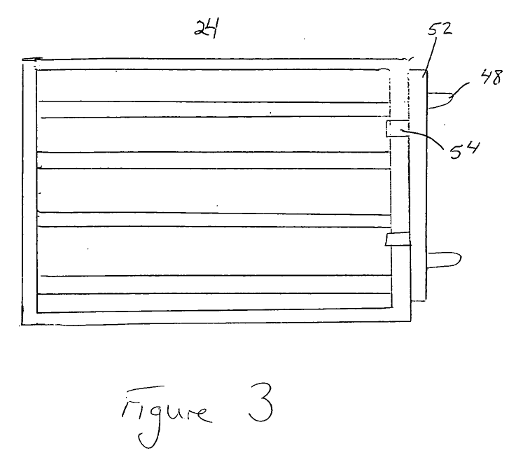

FIG. 3 shows the top view of the operator's cage 24 connection to the protective guard. As can be seen in this depiction, the top of the cage has a series of slats. At least one hook extends from the top rail 52, with one leg of the L-shaped hook extending over the top of the cage and the second leg extending downwardly. Other shapes of hooks may be used in place of the L-shaped hook depicted.

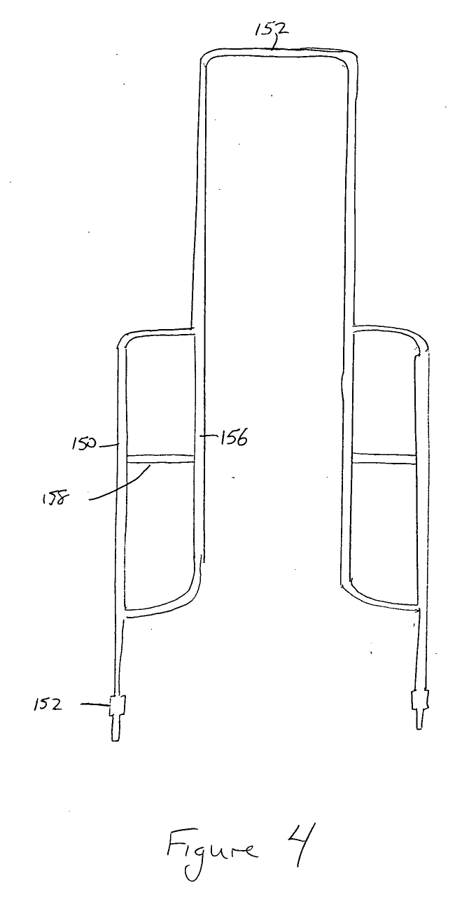

FIG. 4 shows an alternative embodiment of the guard rail. Vertical posts 150 have stops 152 near their terminal end. That section below the stop 152 would fit into an aperture of the operator's platform. In this embodiment, the inwardly extending extensions 156 has a vertical extent greater than the vertical post 150. The vertical post 150 have a top portion extending inwardly and joining the extension 156. The two extensions are joined to one another at their top by a top rail 152. A cross member 158 extends between the vertical posts 150 and extension 156 to provide greater stability and strength. This embodiment creates a narrower opening through which falling inventory can pass.

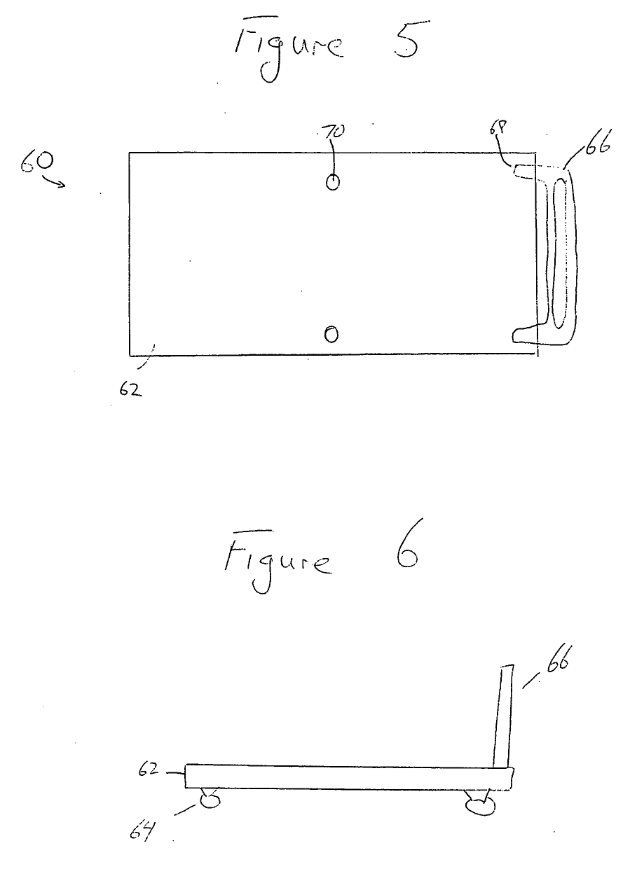

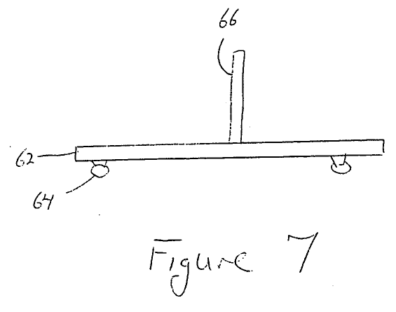

FIG. 5 shows a flat useable with the order picker of the invention. The flat 60 has a bed 62 and a fence 66. The fence 66 has two legs engaging apertures 68 towards the rear edge of the bed. Additional sets of apertures 70 are provided in the middle of the bed. FIG. 6 shows how the bed is supported on wheel 64 for movement. Channels under the bed 62 (not shown) receive the forks 18 from the order picker. The fence 66 in a rearward position.

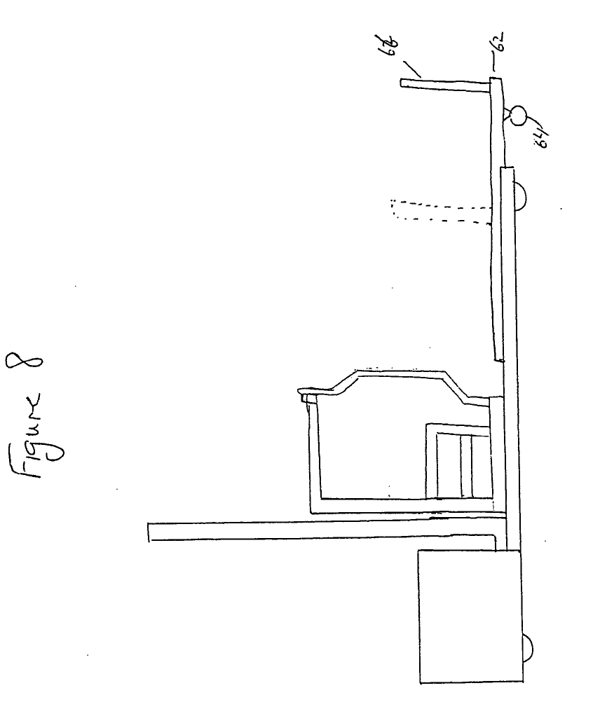

FIG. 7 shows the fence moved to the second position wherein the legs of the fence 66 are held in position by apertures 70. Although only one additional set of apertures is shown, any number of apertures may be provided along the length of the bed, allowing the fence to be positioned along a variety of positions.

FIG. 8 shows how the order picker and flat 60 operate together. The space between the protective guard, attached to the operator's cab, and the fence of the flat can be adjusted by moving the fence to an appropriate set of apertures in the bed 62. The fence is shown in the rearward position with the middle position shown in phantom. In this manner, the space between the protective guard and fence can be customized so that it is appropriate for the size of the merchandise being carried. The reduced space between the protective guard and fence prevents shifting and falling of the merchandise. When the flat and forks are in the fully lowered position, the flat may be rolled from the order picker on wheels 64.

While the invention has been described with reference to the preferred embodiment, various modifications would be apparent to one of ordinary skill in the art. The invention encompasses such variations and modifications without departing from the scope of the invention. For instance, the protective guard can be used on any device to protect the operator from injury, such as forklifts.

1. An order picker, comprising
a frame having a front and a rear,
a motor for providing power at said front of said frame,
an operator's platform for supporting an operator located rearwardly of said motor, said platform having a front edge, a rear edge, and a pair of side edges,
a protective guard extending upwardly from said platform rear edge.

2. The order picker of claim 1, further comprising
a pair of forks for supporting merchandise located rearwardly of said platform.

3. The order picker of claim 1, further comprising
an operator's cab comprising a vertical portion of said platform front edge and a horizontal portion extending from said vertical portion.

4. The order picker of claim 3, wherein
said protective guard is attached to said cab horizontal portion.

5. The order picker of claim 4, wherein
said protective guard comprises a pair of vertical posts and a top rail extending between said vertical posts,
at least one hook extending from said top rail for engaging said cab horizontal portion.

6. The order picker of claim 5, wherein
said hook is L-shaped.

7. The order picker of claim 5, further comprising an extension attached to each vertical post, each extension extending inwardly toward one another.

8. The order picker of claim 7, wherein
each extension is U shaped.

9. The order picker of claim 1, wherein
said protective guard comprises a pair of vertical posts.

10. The order picker of claim 1, further comprising
a top rail extending between said pair of vertical posts.

11. The order picker of claim 9, further comprising an extension attached to each vertical post, each extension extending inwardly.

12. The order picker of claim 11, wherein
each extension is U-shaped.

13. The order picker of claim 9, wherein
each vertical post has a first section and a second section, said second section extending rearwardly of said first section.

14. The order picker of claim 9 wherein
each vertical post comprises
a first vertical section extending from said operator's platform,
a second rearwardly extending section attached to said first section,
a third vertical section extending upwardly from said second section,
a fourth forwardly extending section attached to said third section,
a fifth vertical section extending upwardly from said fourth section.

15. The order picker of claim 2, further comprising
a flat for carrying merchandise engaged by said forks, said flat comprising
a bed, and
a fence extending upwardly from said bed, said fence positionable at a plurality of locations along said bed to adjust said distance between said fence and said protective guard.

16. The order picker of claim 15, wherein
said fence has a pair of legs,
said bed has a plurality of pairs of apertures, said fence retained on said bed by said pair of legs engaging a pair of apertures.

17. The order picker of claim 15, further comprising
wheels attached to the bottom of said flat, said flat being able to roll from said order picker when said forks are in the lowest position.

18. A protective guard, comprising
a pair of vertical posts, each vertical post has a first section and a second section, said second section extending rearwardly of said first section, and
a top rail extending between said pair of vertical posts.

19. The protective guard of claim 18, wherein
each vertical post comprises
a first vertical section,
a second rearwardly extending section attached to said first section,
a third vertical section extending upwardly from said second section,
a fourth forwardly extending section attached to said third section,
a fifth vertical section extending upwardly from said fourth section.

20. The protective guard of claim 18, further comprising an extension attached to each vertical post, each extension extending inwardly toward one another.

21. The protective guard of claim 20, wherein
each extension is U-shaped.

22. The protective guard of claim 18, further comprising at least one hook attached to said top rail.

23. The protective guard of claim 22, wherein said at least one hook is L shaped.

24. A method of protecting an operator of an order picker, comprising
providing an order picker having a frame having a front and a rear,
a motor for providing power at said front of said frame,
an operator's platform for supporting an operator located rearwardly of said motor, said platform having a front edge, a rear edge, and a pair of side edges, and
attaching a protective guard extending upwardly from said platform rear edge.

25. The method of claim 24, further comprising
an operator's cab comprising a vertical portion of said platform front edge and a horizontal portion extending from said vertical portion, and
attaching said protective guard to said cab horizontal portion.

26. The method of claim 24, wherein
the protective guard is attached to said cab horizontal portion by at least one hook.

27. The method of claim 26, wherein said at least one hook is L-shaped.

28. The method of claim 24, further comprising
forming said protective guard with two vertical posts.

29. The method of claim 28, further comprising
forming an extension on each vertical post, said extensions extending inwardly toward one another.

30. The method of claim 29, further comprising
forming said extensions in a U-shape.
